(19) United States
(12) Patent Application Publication
(10) Pub. No.: US 2010/0269309 A1
(43) Pub. Date: Oct. 28, 2010

(54) CLOTHES PEG

(75) Inventors: Giorgio Boesi, Bergamo (IT); Antonello Signorelli, Bergamo (IT); Maurizio Signorelli, Bergamo (IT)

Correspondence Address: KING & SCHICKLI, PLLC, 247 NORTH BROADWAY, LEXINGTON, KY, 40507, US

(73) Assignee: OMAHA S.R.L.

(21) Appl. No.: 12/809,640

(22) PCT Filed: Dec. 12, 2008
(86) PCT No.: PCT/IB08/03436

§ 371 Date: Jun. 21, 2010

(30) Foreign Application Priority Data
Dec. 20, 2007 (IT) BG2007A000060
Sep. 5, 2008 (IT) BG2008A000044

(51) Int. Cl. D06F 55/00; H01F 7/00

(52) U.S. Cl. 24/303

(57) ABSTRACT

A peg (10) comprising two prolonged elements (11,12); said two elements having a front portion (13,14) in the form of a clamp and a rear portion (15,16) able to be gripped by the fingers; said peg comprising means for connecting said two elements together (17), positioned substantially at the centre of the length of said two elements, characterised in that one of said two elements comprises within said front portion at least one first magnet (20) and the other of said two elements comprises at least one second magnet or a magnetic material (21).

The present invention relates to a clothes peg.

Clothes pegs are normally made of plastic, wood or metal, all deriving from a mechanical concept represented by two clamping ends kept constantly under pressure by steel springs or pressed against each other by virtue of the particular shape of the peg itself. These pegs are formed either as two mating parts connected together by a spring or as a single piece in which the spring does not provide the connecting function but only the pressing function for suspending the clothes.

However all the current solutions present certain limitations deriving mainly from two problems, namely the reduction in clamping pressure with time and the large amount of marks (creases) left on the clothes clamped by the pegs, in particular about the clotheshorse rod.

The pressure exerted by the metal springs can decrease as a result of the loss of initial characteristics of the metal, as these components are intended for external use, hence subjected to temperature variations, UV rays and, in many areas, corrosive saline mist.

The pressure produced can hence be progressively lost with time, so making the peg unusable.

This limitation is more severe in those types formed in two parts connected together by a spring, which also lose cohesion by the tendency of the two parts to shift out of alignment as an evident result of loss of retention by the spring.

Most pegs present a shape with one or more rounded seats spaced by pressure ends kept constantly close together by compression springs.

These pegs are expressly designed to suspend clothes by wrapping these latter or a part thereof about the clotheshorse rod (or cord) and pressing against them. In this manner the suspended clothes undergo double deformation, one due to their wrapping about the rod to correctly position them, and the other due to their gripping.

An object of the present invention is to provide a clothes peg which solves the problems of the known art, i.e. to reduce as much as possible any suspension marks left on the clothes and to provide a peg which does not lose its effectiveness with the passage of time. Another object is to provide a multi-purpose peg.

A further object is to enable it to be constructed simply and at low cost.

These and further objects are attained according to the present invention by a peg comprising two prolonged elements; said two elements having a front portion in the form of a clamp and a rear portion able to be gripped by the fingers; said peg comprising means for connecting said two elements together, positioned substantially at the centre of the length of said two elements, characterised in that one of said two elements comprises within said front portion at least one first magnet and the other of said two elements comprises at least one second magnet or a magnetic material.

Further characteristics of the invention are described in the dependent claims.

A non-conventional peg is proposed, formed in a manner conceptually different from the known art, in terms both of its mechanical part and of its method of use.

The proposed peg does not present any type of retention spring, but instead its two end parts are maintained in constant contact one against the other by the presence of one or more magnets inserted into these ends.

The force exerted by the magnet against the opposite part, whether this be another magnet or a steel (or iron) adhesion element, determines the continuous attraction of the peg clamping ends, which hence retain the clothes without them necessarily having to be gripped about the clotheshorse rod.

The peg described herein determines an exact simulation of the gripping action performed by the two fingers of a hand, by which action the clothes are retained but not forcibly gripped about the rod. If, for retention under windy atmospheric conditions, it is considered preferable to partially wrap a portion of the clothes fabric about the rod for “safety” reasons, the peg, by virtue of the large recesses provided, acts without gripping against the rod, its action being limited to pressure by the two ends provided with magnetic attraction. Finally a peg is proposed which in addition to its improved functionality can also be perfumed and/or coloured.

It can be advantageously used to perfume the clothes, for example by placing it in drawers in which the clothes are placed.

The characteristics and advantages of the present invention will be apparent from the ensuing detailed description of one embodiment thereof, illustrated by way of non-limiting example in the accompanying drawings, in which:

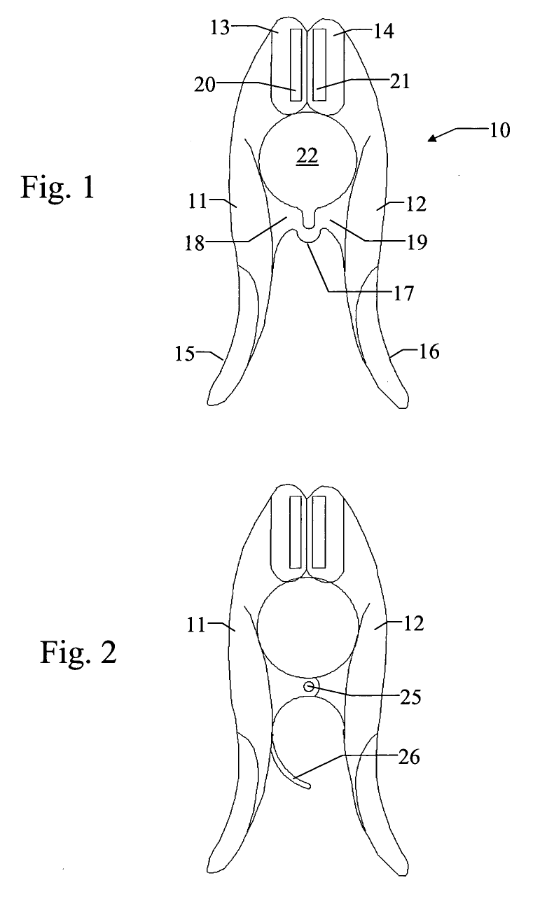

FIG. 1 is a partly sectional schematic plan view of a first embodiment of a peg according to the present invention;

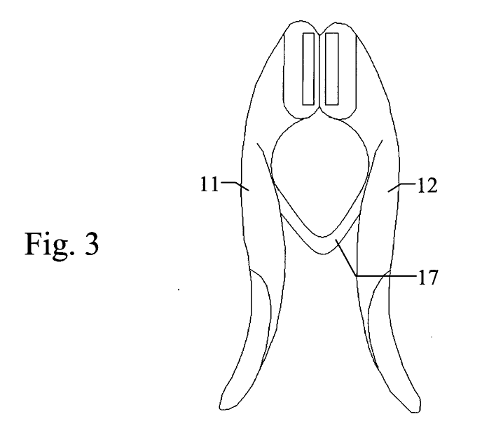

FIG. 2 is a partly sectional schematic plan view of a second embodiment of a peg according to the present invention;

FIG. 3 is a partly sectional schematic plan view of a third embodiment of a peg according to the present invention.

With reference to the accompanying figures, a clothes peg 10 of the present invention comprises a first element 11 and a second element 12, having a front portion 13 and 14 in the form of a clamp and an outer rear portion 15 and 16 able to be gripped by the fingers.

A connection piece 17 connects the two elements 11 and 12 together. It is positioned substantially in the centre of the length of the elements 11 and 12. The connection piece 17 is preferably of U-shape, the ends of the U being connected one to a protuberance 18 of the element 11 and the other to a protuberance 19 of the element 12.

The connection piece 17 has also a function equivalent to that of a spring.

The U shape is chosen to reduce the forces on this piece during the use of the peg 10. Alternatively, the piece 17 can be merely a substantially straight element of suitable thickness for the force arising from the opening and closure of the peg 10.

In an alternative embodiment, the elements 11 and 12 can be made separate from each other and connected together by a plastic or metal spring or other means suitable for the connection. For example, they can be connected together by a pin 25, and comprise a spring 26.

Two magnets 20 and 21 are incorporated into the front portions 13 and 14 of the elements 11 and 12. The magnets have preferably a diameter of 1 cm and are made of neodymium.

Alternatively, the element 20 can be a magnet and the element 21 a magnetic material (steel or iron, plastoferrite, etc.), which is attracted by the magnet 20. In a less preferable alternative embodiment, the magnets 20 and 21 are glued to the outside of the elements 11 and 12.

In another embodiment, the part 17 extends directly from the elements 11 and 12, and is in the form of a V-shaped or curved plastic element (rod) of small dimensions.

Several magnets can also be used, possibly of smaller dimensions, for each of the elements 11 and 12. Alternatively, each magnet can be coupled to a ferrous element to increase its attraction force.

In the portion between the part 17 and the front portions 13 and 14 the peg 10 comprises an internal recess between the elements 11 and 12. This has a radius greater than 1 cm and is preferably equal to 2 cm.

The peg is made of polypropylene, but other plastic materials can be used.

In particular, the peg 10 is formed using two moulds, one for the body consisting of the elements 11 and 12 with the exception of the front portions 13 and 14, and the other for these latter portions.

The front portions 13 and 14 are formed separately to enable the magnetic elements 20 and 21 to be joined to them. After this, they are assembled with the peg body (elements 11 and 12) by pressfitting and/or with the aid of glue.

Advantageously, one or more essential oils are mixed with the polypropylene granules to add perfume to the product obtained. In particular, the perfume is added only to those granules used to mould the peg body and not those used for the front portions 13 and 14, so that the perfumed areas do not come into contact with the clothes. The perfume can be added to the granules either in liquid form or as perfumed resin matrices.

The method of constructing the peg 10 will not be described in detail, as an expert of the art is able to form the peg based on the aforegoing description.

The benefits of the present invention hence derive from the disappearance of the problems of the known art. In this respect, the magnetic retention system cannot lose adhesion with time, as the magnetic element and its opposite piece (magnet or iron) are protected by the peg body and are hence not exposed to degrading atmospheric agents.

Secondly, the pressing action exerted on the clothes is limited to the minimum fabric portion indispensible for the suspension, without necessarily acting on the clotheshorse rod or cord: consequently extremely small marks are left on the fabric.

This particular characteristic of the peg of the invention provides an advantage which emerges after the clothes washing operations, i.e. during ironing, which is made simple and economical (in terms of energy saving) because of the reduction in peg marks, which disappear by a simple passage of the iron or, with some fabrics, by simply rubbing the article of clothing with the hands in proximity to the pressure marks.

Another advantageous characteristic is the perfuming and/or colouring of the peg, in particular of the peg body, which makes it an article which, in addition to being useful, is very pleasant and at the same time usable for perfuming the surroundings in addition to the clothes.

The system conceived in this manner is susceptible to numerous modifications and variants, all falling within the scope of the inventive concept; in addition all details can be replaced by technically equivalent elements.

1.-15. (canceled)

16. A clothes peg, comprising:
two prolonged elements, said two elements having a front portion in the form of a clamp and a rear portion able to be gripped by the fingers;
means for connecting said two elements together, positioned substantially at the centre of the length of said two elements,
further comprising an internal recess in a portion between said connecting means and said front portion, said internal recess having a radius greater than 1 centimeter,
characterised in that one of said two elements comprises within said front portion at least one first magnet and the other of said two elements comprises at least one second magnet or a magnetic material, and said at least one first magnet and said at least one second magnet or magnetic material each have a flat surface.

17. A peg as claimed in claim 16, characterised in that said two elements are coloured.

18. A peg as claimed in claim 16, characterised by being made of plastic material.

19. A peg as claimed in claim 16, characterised in that a perfume is added to said plastic material.

20. A peg as claimed in claim 16, characterised in that said first and second magnet are neodymium magnets.

21. A peg as claimed in claim 16, characterised in that said connection means comprise a V-shaped element of plastic material.

22. A peg as claimed in claim 16, characterised in that said connection means are arranged to form a spring.

23. A peg as claimed in claim 16, characterised in that said first and second magnet are incorporated into said front portion of said two elements.

24. A peg as claimed in claim 16, characterised in that said front portion of said two elements is not perfumed.

25. A peg as claimed in claim 16, characterised by being made of polypropylene.

26. A peg as claimed in claim 16, characterised in that said connection means comprise a substantially straight element of plastic material.

27. A peg as claimed in claim 16, characterised in that said connection means are U-shaped.

28. A peg as claimed in claim 16, characterised in that said means for connecting together said two elements comprise a connection pin.

29. A peg as claimed in claim 16, characterised in that said means for connecting together said two elements comprise a spring of the same material as said peg.
